(19) United States
(12) Patent Application Publication
(10) Pub. No.: US 2018/0134266 A1
(43) Pub. Date: May 17, 2018

(54) HYBRID NON-ABS/ABS BRAKING SYSTEM

(71) Applicant: 3rd Millennium Solutions, Inc., Campbellford (CA)

(72) Inventors: Stephen Lyle McKeown, Kingston (CA); Jeffrey Alan Laidman, Barrie (CA); Paul Edward Cudmore, Castleton (CA)

(21) Appl. No.: 15/593,379

(22) Filed: May 12, 2017

Related U.S. Application Data
(60) Provisional application No. 62/421,545, filed on Nov. 14, 2016.

(51) Int. Cl. B60T 8/176; B60T 8/1755

(52) U.S. Cl. CPC B60T 8/176; B60T 8/17552; B60T 8/17554; B60T 2230/03; B60T 2220/03; B60T 2220/04; B60T 2230/02; B60T 8/17551

(57) ABSTRACT

A method of controlling a hybrid Non-ABS and ABS braking system of a vehicle. The method includes steps of: engaging an initial braking system based on a default setting or input from an operator of the vehicle; acquiring data from at least one sensor associated with the vehicle during the step of engaging the initial braking system; sending the data provided by the at least one sensor to a control module of the vehicle; analyzing the data provided by the at least one sensor; and disengaging the initial braking system and engaging a subsequent braking system when a predetermined condition is detected.

### FIELD

The present disclosure relates generally to vehicle anti-lock braking systems, and more particularly to a braking system that utilizes a non-anti-lock style of braking until a specified condition has been met; thereafter, an anti-lock style of braking may engage.

### BACKGROUND

Anti-lock braking systems (hereinafter referred to as ABS systems) were originally developed to enhance vehicular directional stability under intense braking conditions. Traditionally (i.e., before ABS systems were commonly implemented), vehicles having a non anti-lock braking system (hereinafter referred to as Non-ABS systems) were highly susceptible to their wheels locking up under intense braking conditions. In such situations, the operator would lose a substantial amount of directional control over the vehicle. The ABS system claims several advantages over Non-ABS systems. First, ABS systems will not allow the wheels of the vehicle to “lock up” during intense braking conditions; thus, the vehicle operator is able to remain in directional control by making user inputs and corrections to the steering wheel.

The second advantage is that a tire produces maximum braking at differing slip values, ranging from about 10% to 100% slip, fully locked wheel(s). A vehicle equipped with an ABS system attempts to keep the wheel(s) from completely locking up, 100% slip, thus not allowing the vehicle to be stopped in the shorter distances that a vehicle equipped with a Non-ABS system can almost always attain.

Furthermore, modified ABS systems (called aircraft anti-skid braking systems, or ASBS) have also traditionally been employed in aircraft applications. Aircrafts braking on pavements is an extremely high energy activity and aircrafts having a Non-ABS system are susceptible to tire damage (commonly called ‘bulls eyeing where a brake has locked the wheel to only a small area of contact) or “blowouts”, where the tire is literally ripped apart to explosive deflation as a result of severe braking forces being applied during landing. Aircrafts that utilize an (ASBS) ABS system enjoy a reduced chance of such damage occurring, as aircraft ASBS ABS systems limit the braking force.

Originally, in some countries, ABS systems were not actually required to “brake” within certain decelerative braking performance requirements, but were instead required to not cause a vehicle to “skid” out of a predetermined radius circle at a predetermined speed on a described friction availability pavement surface. In meeting these requirements, ABS system manufacturers were left to their own judgment about how their operational braking algorithms applied. Such factors considered by the manufacturers were: certification criteria; desired vehicle control, dynamic stresses, and operator comfort.

Many patents have been issued on different control schemes to operate an ABS system. While the theory is straightforward, successfully implementing said theory into real world scenarios, where conditions and variables fluctuate frequently is not. Firstly, the condition at which maximum braking force is achieved is an inherently unstable highly condition specific variable position; slight changes caused by variations in road surfaces and contaminations like water, snow, slush, sand, de-icing chemicals, and ice have the undesired tendency to decrease the braking force, or even cause wheel lock. To compensate for such undesired activity, ABS systems will continuously cycle braking pressures in an attempt to sustain maximum directional control, but not maximum braking effectiveness.

To further complicate the matter, the condition at which maximum braking force is achieved is not dependent on the frictional coefficient of the pavement, but rather, is dependent on the braking characteristics of the actual environment of the tire to ‘surface’ interface, which, when contaminants are present, cause the braking action, which is the action of causing the tire circumferential speed to be lower than the ground speed of the vehicle (the ‘slip ratio’) to occur. On a vehicle like a passenger car, ABS brakes, if mounted on all axles and wheels, prevent the wheels from ‘locking’ up at 100% slip, and modulate braking forces as quickly as their design allows to do this. An aircraft ASBS ABS system also limits brake pressure to prevent excessive tire damage. By limiting maximum braking forces aircraft with ASBS ABS system apply a different control system that instead of just preventing wheel lock up, they also include controls to prevent unacceptable deceleration rates of the wheels and/or try to prevent the braking of the wheels beyond a certain slip % threshold value.

In regards to the above noted problem, a study was completed by Transport Canada on the performance of vehicles equipped with ABS systems on deformable surfaces, such as snow. The study was prompted by a high volume of public complaints concerning unexpected stopping distances when surface coefficients were impaired by snow, slush, and gravel. Preliminary results indicated that a vehicle—utilizing a Non-ABS system—averaged 39% and 27% shorter stopping distances in loose snow and loosely compacted snow, respectively, than a vehicle with an ABS system. See Battista, V., “Performance of ABS-Equipped Vehicles on Deformable Surfaces,” Proceedings of the Canadian Multidisciplinary Road Safety Conference XII, London, Ontario, 2001. The inventors have also carried out braking testing of a passenger car in wet snow with stopping distances as much as 900% higher with ABS braking left enabled than with ABS disabled in snow on a negative (downhill) grade.

There are many circumstances where the ability to directionally control the vehicle may be of less importance than the ability to brake in a shorter distance. One such example would be approaching a busy roadway intersection at a high rate of speed; the need to directionally control the vehicle is of less importance in such an emergency situation than the need to stop the vehicle within a shorter distance. If there is some form of contaminant on the surface, then the need for decreased stopping distance outweighs the need for directional control of the vehicle, and it would be advantageous to have a Non-ABS braking system. However, if the wheels locked up and the vehicle began excessively rotating around its center of gravity vertical axis to a point where the vehicle ‘condition’ might cause danger or loss of safe control, this invention could sense the increasing condition early, and change the braking system to hybrid (example ABS brakes to rear wheels only, Non-ABS to front wheels, or, a change to an Electronic Stability Control influenced ABS, or Non ABS, or Hybrid Non-ABS ABS system).

Or, while the vehicle was entering or exiting a turn, an unacceptable condition may arise where directional control over the vehicle would be of utmost importance, and thus, it would also be often advantageous to be able to engage an ABS braking system.

### SUMMARY

There are set forth designs and methods for a hybrid Non-ABS/ABS braking system (Hereinafter referred to as “HNAABS braking system”) suited to allow vehicles employing such an HNAABS braking system to operate more successfully while traversing over contaminated surfaces, as well as experiencing superior maneuverability when the vehicle operates under unacceptable conditions. The following presents a simplified summary of the disclosure in order to provide a basic understanding of some example aspects described in the detailed description.

One embodiment of the present application discloses an HNAABS braking system to be employed in a vehicle. The vehicle may be of any type of vehicle requiring braking forces (e.g., cars, sport utility vehicles [SUV], trucks, commercial trucks, motorcycles, all-terrain vehicles [ATV], off-road vehicles, aircrafts, etc.). The HNAABS braking system may comprise at least one sensor (e.g., a steering sensor, a braking sensor, a directional dynamics sensor, etc.), and a control module. The control module is configured to engage a braking system (e.g., an ABS braking system, a Non-ABS braking system, etc.) upon the detection of an unacceptable condition. The method of controlling the HNAABS braking system may include the steps of: engaging a vehicle's initial braking system; acquiring data from at least one sensor and sending the data to a control module; detecting whether a condition has occurred (e.g., solving an algorithmic equation), and switching to a subsequent braking system employed by the vehicle upon detecting the condition.

In essence, the vehicle may initially employ a Non-ABS braking system, thereby allowing for a “Non-ABS style” of braking whenever the operator uses the brakes of the vehicle; in the event that an unacceptable condition is thereafter detected (e.g., understeering, oversteering, fishtailing, etc.), the control module will output commands to the HNAABS braking system, therein simultaneously or sequentially disengaging the Non-ABS braking system, and engaging an ABS braking system in order to employ an “ABS style” of braking which may allow for superior maneuverability.

Alternatively, the vehicle may initially employ an ABS braking system to one or more axles/wheels, thereby allowing for an “ABS style” of braking whenever the operator uses the brakes of the vehicle; in the event that an unacceptable condition is sensed (e.g., insubstantial braking forces; unstabilizing surface conditions, etc.), the control module will output commands to the HNAABS braking system, therein simultaneously or sequentially disengaging the ABS braking system, and engaging a Non-ABS braking system in order to employ an “Non-ABS style” of braking to one or more axles/wheels, which may allow for superior deceleration in unstable surface conditions.

The method of controlling the HNAABS braking system may operate in a looped fashion, so as to constantly be analyzing data acquired from the at least one sensor, and switching to a subsequent braking system depending on the detection of an unacceptable condition.

In accordance with one aspect, there is provided a method of controlling a hybrid Non-ABS and ABS braking system of a vehicle. The method includes steps of: engaging an initial braking system based on input from an operator of the vehicle; acquiring data from at least one sensor associated with the vehicle during the step of engaging the initial braking system; sending the data provided by the at least one sensor to a control module of the vehicle; analyzing the data provided by the at least one sensor; and disengaging the initial braking system and engaging a subsequent braking system when a predetermined condition is detected by the control module.

In accordance with another aspect, there is provided a method of controlling a hybrid Non-ABS and ABS braking system of a vehicle. The method includes steps of: engaging an initial braking system comprised of Non-ABS braking, wherein the Non-ABS braking allows wheels of the vehicle to be braked up to being fully locked during braking; acquiring data from at least one sensor associated with the vehicle; sending the data provided by the at least one sensor to a control module of the vehicle; analyzing the data provided by the at least one sensor; and disengaging the initial braking system and engaging a subsequent braking system when a predetermined condition is detected.

It is to be understood that both the foregoing general description and the following detailed description present embodiments of the present disclosure, and are intended to provide an overview of framework for understanding the nature and character of the embodiments as they are described and claimed. The accompanying drawings are included to provide a further understanding of the embodiments, and are incorporated into and constitute a part of this specification. The drawings illustrate various embodiments of the disclosure, and together with the description, serve to explain the principles and operations thereof.

### BRIEF DESCRIPTION OF THE DRAWINGS

The above and other features, aspects, and advantages of the present application are better understood when the following detailed description of the present application is read with reference to the accompanying drawings, in which:

FIG. 1 is an architectural diagram of one embodiment of a hybrid Non-ABS/ABS braking system;

FIG. 2 is an architectural diagram of another embodiment of a hybrid Non-ABS/ABS braking system; and

FIG. 3 is a functional block diagram of one embodiment of a hybrid Non-ABS/ABS braking system.

### DETAILED DESCRIPTION

The following is a detailed description of illustrative embodiments of the present application. As these embodiments of the present application are described with reference to the aforementioned drawings, various modifications or adaptations of the methods and or specific structures described may become apparent to those skilled in the art. All such modifications, adaptations, or variations that rely upon the teachings of the present application, and through which these teachings have advanced the art, are considered to be within the spirit and scope of the present application. Hence, these descriptions and drawings are not to be considered in a limiting sense as it is understood that the present application is in no way limited to the embodiments illustrated.

As briefly indicated above, in various embodiments, the present application provides methodology for the operation of a vehicle employing a hybrid non-ABS/ABS braking system (hereinafter referred to as “HNAABS braking system”).

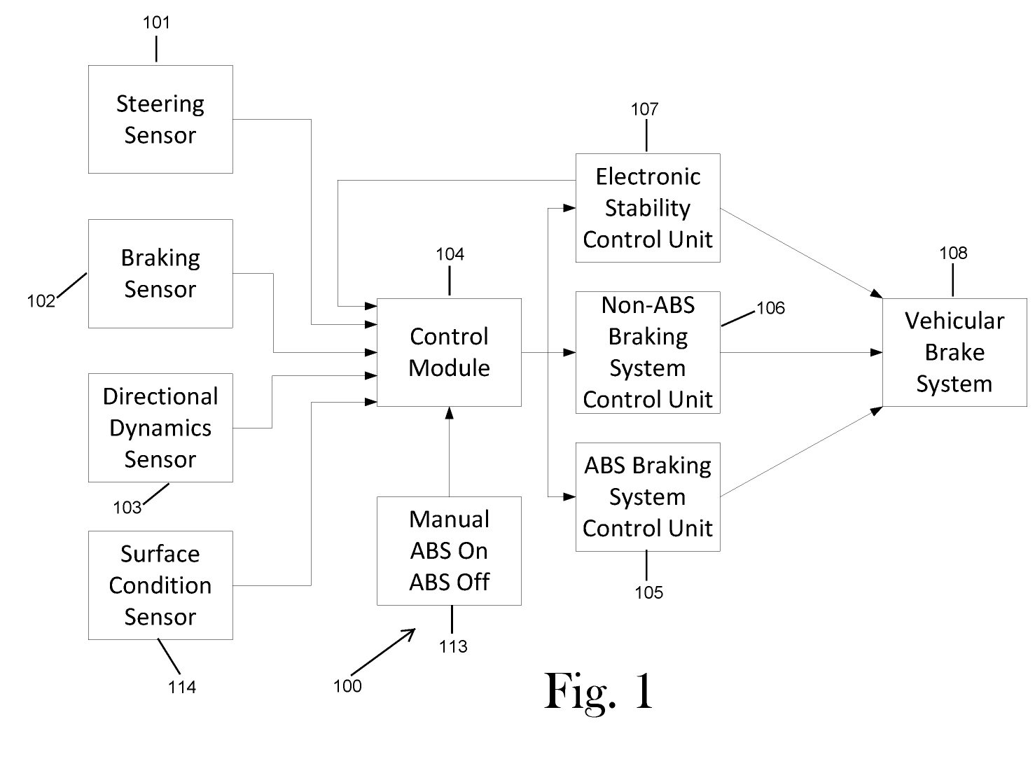

Referring to FIG. 1, an architectural diagram of one embodiment of the HNAABS braking system 100 is shown. As visually depicted in FIG. 1, the HNAABS braking system 100 includes at least one sensor; for example, the at least one sensor may include a steering sensor 101, a braking sensor 102, and/or a directional dynamics sensor 103. Other sensors may further be used in the employment of the HNAABS system (e.g., pressure sensors, temperature sensors, position sensors, wearing sensors, visual sensors, etc.). Electrical connections may be employed between said sensor and a device to be sensed in order to acquire data therefrom. Alternatively, said sensor may use visual detection, or any other detection method, in order to acquire data therefrom.

The steering sensor 101 may be positioned at various locations within the vehicle. For example, the steering sensor 101 may be positioned: on or at a distance away from a steering column; directly on or within a vehicular steering device (e.g., steering wheel, joy stick, etc.); or at a distance away from the vehicular steering device, such as a downstream component (e.g., front and/or rear axles, wheel hub, vehicular suspension, etc.).

The steering sensor 101 may be configured to acquire various data pertaining to the steering column, vehicular steering device, and/or downstream component; for example such data to be acquired may include: current and/or changed positions; the rate at which the position changes; or any other such information relative to directional inputs. The data may be acquired by the employment of electrical connections, visually sensing, or any other method of acquiring data.

The braking sensor 102 may be located directly on or within a braking device (e.g., brake pedal, brake lever, joy stick, etc.). Alternatively, the braking sensor 102 may be positioned at a distance away from the braking device, such as a downstream component (e.g., brake lines, brake cylinders, brake calipers, vehicular suspension, etc.).

The braking sensor 102 may be configured to acquire various data pertaining to the braking device, and/or downstream components; for example, such data to be acquired may include: current and/or changed positions; the rate at which the position changes; brake system pressures; or any other such information relative to braking inputs.

The directional dynamics sensor 103 may be positioned at various locations within the vehicle. For example, the directional dynamics sensor 103 may be positioned at a central location of the vehicle, or at any outer periphery of the vehicle. Furthermore, the directional dynamics sensor 103 may be removably attached to any structure of the vehicle, or it may be integrally formed within the vehicle (e.g., the directional dynamics sensor 103 may be integrally formed within the frame of the vehicle).

The directional dynamics sensor 103 may sense a current position and/or changed position; direction; lateral, longitudinal, vertical acceleration; rotation around the vertical axis of the center of gravity; of the vehicle, while in motion. Specifically, the directional dynamics sensor 103 may be configured to acquire data pertaining to any information regarding original and/or changed vehicular directional movement (e.g., velocity, acceleration, deceleration, momentum, direction, drag force, G-Force, centrifugal force, etc.).

The surface condition sensor 114 may sense a current surface condition like a change to a gravel or a snow surface while a vehicle is in motion and provide data to the control module that may change the real time braking system from ABS to Non ABS, or to ESC, or a hybrid control like Non ABS on front wheels and ABS on rear or a different ABS style brake pressure modulating system for all, or different sets of wheel brakes. The surface condition sensor 114 may also send sensed data to other systems like ESC and/or ETC (Electronic Traction Control) providing inputs that can be used to alter the control and operation of those systems

Steering sensor 101, Braking sensor 102, Directional Dynamics sensor 103, Surface Condition sensor 114 and Manual control 113 may also send sensed data individually, collectively or in any combination to all of the HNNABS Control Module 104 as well as to any other vehicle system like ESC, ETC, and braking, steering, and acceleration systems and be used by all or any of these systems as inputs to their control and to provide any of audio, visual or tactile feedback to the operators of the vehicle to warn of potential dangers like approaching a vehicle's lateral acceleration rollover threshold, a fishtailing, or understeer, or oversteer condition, and in the case of aircraft and semi autonomous and autonomous vehicles, warn the operator that dangerous conditions may exist that may lead to longer stopping distances required that expected, potential aircraft runway excursions and potential collisions and aviation incursions, especially when HNAABS technology may be integrated into new and existing situational awareness technologies like GPS and RFID and GIS and radar and other technologies.

Referring back to FIG. 1, the HNAABS braking system 100 further includes a control module 104. The control module 104 may be removably attached to any structure of the vehicle, or the control module 104 may be integral with the vehicle. Optionally, the control module 104 may be integrally formed within the vehicle's engine control unit [ECU] or any other control system. Alternatively, the control module 104 may be of a “plug-and-play” styled unit, wherein the control module 104 will plug into the vehicle's already existing ECU, or any other control system, and will function properly without any user adjustments or inputs after installation. In still another example, the control module 104 may be of a “stand-alone” styled unit, wherein the control module 104 will successfully operate independently of the vehicle's already existing ECU, or any other control systems. In still another example, the Control Module 104 may be manually controlled by the operator, using Manual selector 113 to select ABS On, or ABS Off to best suit operating conditions, examples; ABS On, on non contaminated dry, paved surfaces, or, ABS Off on wet, or winter contaminated paved surfaces, or other surfaces like off road, or paced surfaces covered with loose contaminants like sand, mud, gravel, other solids, liquids etc. In still another example Manual Selector 113 may allow the operator to manually select other modes like ESC defaulting to always on, or always off, or on or off automatically while subordinate to the control module. In still another example the Manual selector 113 may allow the operator to select various hybrid braking systems like ABS on rear brakes always on, front brakes ABS always off, or, in another example, any braking systems selected may or may not allow the systems to be dominant or subordinate to the ESC. In still another example the Manual selector 113 may allow the operator to control the wheel braking system utilized normally by the ESC so in certain conditions like loose contaminant on paved surfaces the ESC may select Non ABS braking on some wheels, and ABS braking on other wheels. In another example the Manual control 113 may include the ability for an aircraft flight crew to select a HNAABS aircraft braking system control that changes aircraft auto braking, anti skid braking and both aerodynamic and wheel aircraft braking system controls in response to information provided by any one or all of the sensor controls 101, 102, 103 and 114, or from, as examples, information received by the flight crew from NOTAMs (Notices to Airmen), from ATC (Air Traffic Control), from airline dispatch or from airfield ground crews.

The control module 104 of the HNAABS braking system 100 may be configured to collect and/or analyze the data acquired from the at least one sensor. For example, as shown in FIG. 1, if the HNAABS braking system 100 employs any or all of a steering sensor 101, a braking sensor 102, and/or a directional dynamics sensor 103, then the control module 104 may collect and/or analyze the data acquired from any or all of these three sensors. Such data may be analyzed by the control module 104 by way of solving logic and/or algorithmic equations in order to detect an unacceptable condition.

In still another example, the control module 104 may also be configured to store the data acquired from the at least one sensor. In such an instance where the control module 104 is integrally formed within the vehicle's already existing ECU, the acquired data may be removably stored within the vehicle's ECU or any other control system. In another example, where the control module 104 is of a “plug-and-play” styled unit, the acquired data may be removably stored within the hardware of the control module 104. Alternatively, the acquired data may also be removably stored within the vehicle's ECU. In yet a further example, if the control module 104 were of a “stand-alone” nature, then the acquired data may be removably stored within the hardware of the control module 104.

Referring back to FIG. 1, the HNAABS braking system 100 may further include an electronic stability control unit [ESC] 107, a Non-ABS brake system control unit 106, and an ABS brake system control unit 105. The Non-ABS brake system control unit 106 and the ABS brake system control unit 105 may be configured to apply a “Non-ABS style” or an “ABS style” of braking, respectively. Each control unit may be programmed into the vehicle's ECU (or other control system), or may be programmed into separate hardware. Furthermore, each control unit may be configured to receive an output from the control module 104; for example, any or all of the control units may be electronically connected to the control module 104 by way of a wired connection; alternatively, a wireless connection may be employed to achieve the same result.

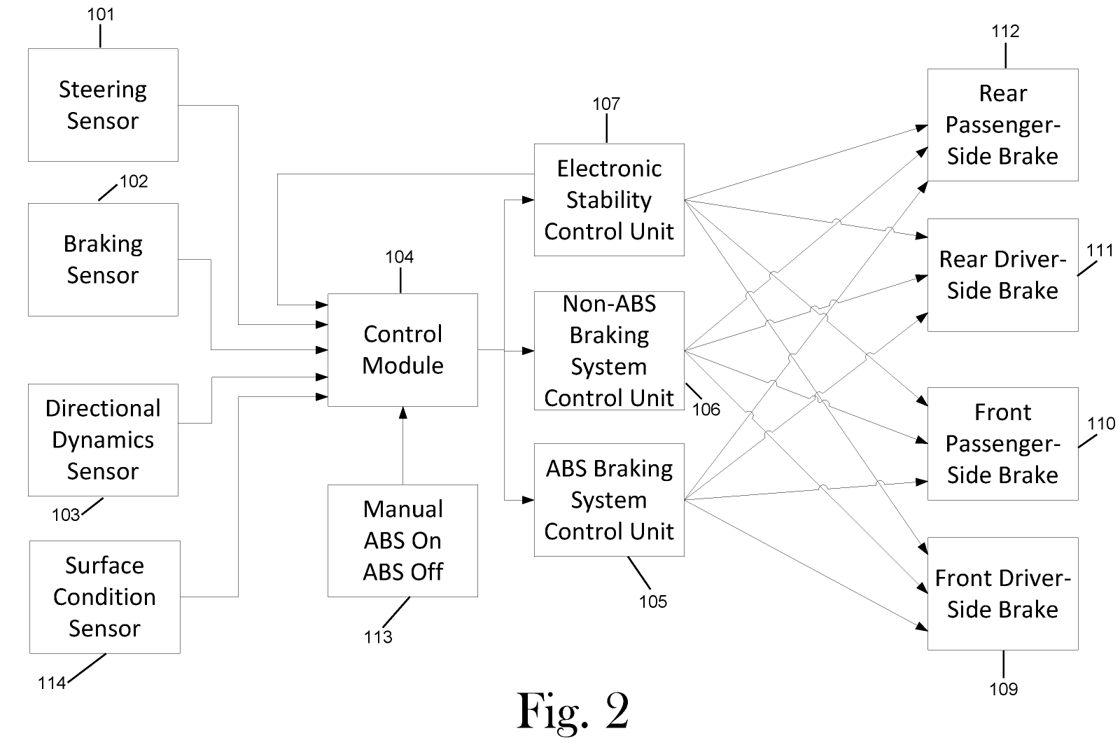

Furthermore, the control units may each be configured to control a vehicular brake system 108, or, alternatively, each control unit may be configured to control an individual brake of the vehicular brake system 108. For example, in such motorized vehicles that utilize four wheels, as is depicted in FIG. 2, the ESC 107, the Non-ABS braking system control unit 106, and the ABS braking system control unit 105 may be configured to control at least one of a rear passenger-side brake 112, a rear driver-side brake 111, a front passenger-side brake 110, and/or a front driver-side brake 109, or any combination of these, as in rear brakes first, left side brakes first, diagonally opposing brakes first, etc.

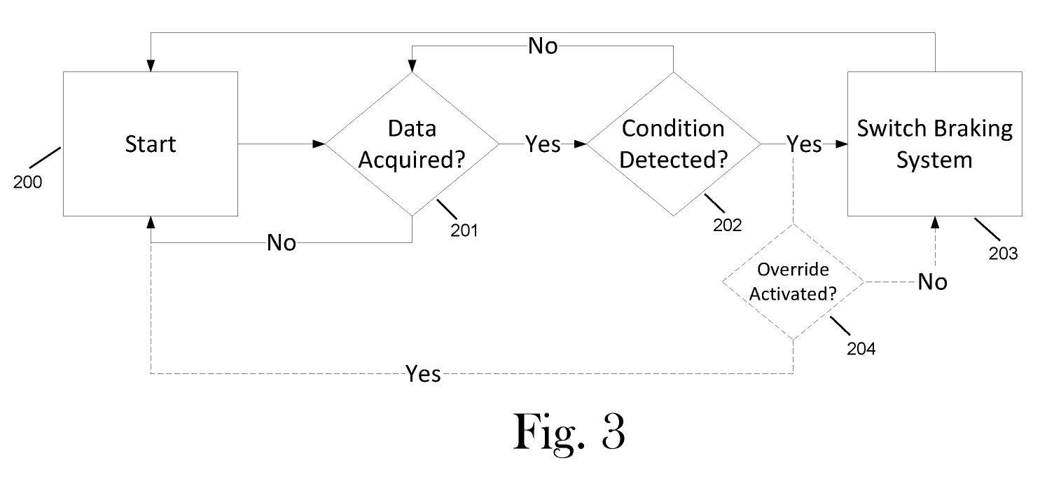

A method of controlling an HNAABS braking system is provided according to various aspects of the present application. Referring to FIG. 3, a functional block diagram is shown for the operation of the HNAABS braking system 100. The method begins at step 200, wherein a vehicle employs an initial braking system; for example, such an initial braking system could be an ABS braking system, or a Non-ABS braking system, wherein said initial braking system will engage an “ABS style” or a “Non-ABS style” of braking, respectively, upon the operator braking the vehicle. Data is acquired at step 201 from various sensors (e.g., steering, braking, directional dynamics, surface condition, etc.), and further analyzed at step 202 to determine whether an unacceptable condition has occurred. If said unacceptable condition has been detected, then, as shown at step 203, the real time or current braking system will be switched to that of a subsequent braking system.

In one example embodiment, as shown in FIG. 3, the method of control begins at step 200, wherein a vehicle employs an initial braking system. The initial braking system may be that of a Non-ABS braking system, wherein, upon the operator braking, the vehicle will engage a Non-ABS style of braking. Alternatively, the initial braking system may be that of an ABS braking system, wherein, upon the operator braking, the vehicle will engage an ABS style of braking. The initial braking system may be a user selected braking system, or may be a pre-programmed and/or default braking system. For example, the vehicle may include more than one pre-programmed braking system, and one of those can be selected as the default mode of operation upon starting the vehicle. The default braking system could be mandated by a governmental body (such as the National Highway Traffic Safety Administration), and may or may not be alterable by the user. Optionally, the user can choose a new default braking system. Furthermore, the initial braking system may be a brake system commanded to be employed by the HNAABS braking system due to the detection of an unacceptable condition (as will later be explained).

The method of controlling the HNAABS braking system further includes step 201, wherein various data is acquired from at least one sensor. For example, as shown in FIGS. 1-2, the data may be acquired from at least one of a steering sensor 101, a braking sensor 102, and/or a directional dynamics sensor 103. After the data has been acquired from at least one sensor, then that data is sent to the control module 104.

The method of controlling the HNAABS braking system further includes step 202, wherein the HNAABS braking system attempts to detect whether or not a predetermined unacceptable condition has occurred. This is accomplished by way of analyzing the various data that has been received by the control module 104. In one example, the control module 104 may process the data and analyze it by solving an algorithmic equation to determine if an unacceptable condition has occurred. In another example, the unacceptable condition may be detected by comparing the data to various predetermined threshold limits. Still further, the unacceptable condition may be detected by any such method for determining whether or not a condition has occurred.

In one example, the unacceptable condition to be detected could be that of understeering. Understeering generally occurs during vehicular turning when there exists a low coefficient of friction between the front wheel (or wheels) of the vehicle, and the surface. Such an occurrence will often take place whenever the operator of the vehicle applies intense braking while entering the corner, or at the apex of a turn. The vehicle will enter a turn with too high of a velocity; in an attempt to correct the miscalculation, the vehicle operator will apply a substantial amount of braking force. The momentum the vehicle is carrying into the turn, coupled with the sudden application of a substantial braking force, will greatly reduce the coefficient of friction between the front wheel (or wheels) of the vehicle and the surface, thus forcing the vehicle to exit the corner at a greater angle than its angle of entry, despite applying the correct steering angle. Understeering can also occur when there is not enough surface traction to provide the front tires with the grip needed to laterally accelerate the front of the vehicle.

In another example, the unacceptable condition may be that a vehicle is traveling too fast to execute a turn on a contaminated surface that might cause an ASBS or ABS equipped vehicle to understeer because there is not enough friction or traction available between the tires and the road surface to laterally accelerate (turn, or rotate) the vehicle because the ASBS or ABS system has not been able to decelerate the vehicle to a point where the friction or traction to turn or rotate the vehicle is high enough to laterally accelerate or turn the vehicle while travelling at the higher speed that could be reduced through higher, non ASBS/ABS braking.

In another example, the unacceptable condition to be detected could be that of oversteering. Oversteering also generally occurs during vehicular turning; however, this unacceptable condition is brought on by a low coefficient of friction between the rear wheel (or wheels) of the vehicle, and the surface. Such an occurrence will often take place when the operator of the vehicle applies an unnecessary amount of power to the vehicle (via a throttle), either before, during, or after the apex of a turn. The momentum carried by the vehicle entering the turn, coupled with the unnecessary amount of power, may greatly reduce the coefficient of friction between the rear wheel (or wheels) of the vehicle and the surface; thus resulting in the operator losing control of the rear of the vehicle.

In comparison to understeering, oversteering is generally easier to control; such a conclusion is predicated on the fact that the operator still has the ability to steer the front end of the vehicle. The operator can attempt to correct the oversteering condition by counter-steering the vehicle (i.e., steering the car in the opposite direction of the vehicle rotation). Furthermore, the operator may also employ a lesser amount of throttle to correct oversteering. If successfully performed, the operator will be able to regain control of the rear end of the vehicle.

However, in the alternative, if the operator applies too much Non ABS braking the rear wheels may lose traction causing the vehicle to rotate in a clockwise or counter clockwise way around the vertical axis of the vehicle's center of gravity. The resulting unacceptable condition is known as fishtailing, which can be yet another unacceptable condition to be detected. In this example the HNAABS system would often initiate and early in the rotation response to switch from Non ANS to ABS braking in the rear axle or wheel(s) if the initial braking in the fishtailing event was Non ABS. Further yet, the unacceptable condition to be detected may be any condition wherein the operator loses directional control of the vehicle (e.g., the vehicle approaches a rollover threshold, etc.).

Alternatively, the unacceptable condition to be detected could be a condition other than the operator losing directional control of the vehicle (i.e., understeering, oversteering, fishtailing, etc.). For example, the vehicle may be traversing in a straight line upon an unstable surface condition (e.g., snow, slush, rain, sand, gravel, oil, etc.); in such a scenario, the unacceptable condition to be detected may be that of a substantial braking force wherein the need to stop the vehicle in a shorter distance outweighs any need to have improved maneuverability.

The method of controlling the HNAABS braking system yet further includes step 203, wherein, upon the detection of the unacceptable condition, the initial braking system employed will be disengaged, and a subsequent braking system to be employed will be engaged. Optionally, the method can include an override feature at step 204, which can be interposed between steps 202 and 203. The override feature can allow a user to manually override the system's disengagement of the initial braking system regardless of whether there was a detection of the unacceptable condition. Thus, upon detection of an unacceptable condition, the method first moves to step 204 to determine whether the override option is activated, and if so, returns the method back to the start at step 200 without changing over to the subsequent braking system. If the override features is not activated, the system would otherwise proceed normally to step 203. The optional override feature could be implemented by a user-selectable hardware or software switch or the like, and could be the same as, or operate together with, the previously described Manual Selector 113. It is contemplated that the override feature could be used by the operator of the vehicle under certain conditions where the user does not want the vehicle to switch braking systems. It is further contemplated that the vehicle itself could automatically activate the override feature as part of the user selecting a particular vehicle mode of operation that affects other vehicle components (i.e., suspension, engine performance, transmission performance, etc.), such as vehicle operation modes for ice, sand, mud, dirt, rocks, etc. In another example, the vehicle could automatically activate the override feature when the Manual Selector 113 is used by the operator.

In one example, the initial braking system may be a Non-Abs braking system. After the control module 104 has analyzed the data acquired from at least one sensor, and has detected an unacceptable condition, the control module 104 may send a signal to any one of the ESC 107, the Non-ABS braking system control unit 106, and/or the ABS braking system control unit 105 in order for said control units to perform a specified function.

For example, as shown in FIG. 2, the control module 104 may output a command to the Non-ABS braking system control unit 106 to disengage a Non-ABS style of braking to at least one of the rear passenger-side brake 112, the rear driver-side brake 111, the front passenger-side brake 110, and/or the front driver-side brake 109. Simultaneously, or sequentially, the control module 104 may output a command to the ABS braking system control unit 105 to engage and apply an ABS style of braking to at least one of the rear passenger-side brake 112, the rear driver-side brake 111, the front passenger-side brake 110, and/or the front driver-side brake 109.

In an alternative example, the initial braking system employed in the vehicle may be an ABS braking system, wherein, upon the detection of a predetermined unacceptable condition, the control module 104 may output a command to the ABS braking system control unit 105 to disengage an ABS style of braking while simultaneously, or sequentially, outputting a command to the Non-ABS braking system control unit 106 to engage and apply a Non-ABS style of braking to at least one of the rear passenger-side brake 112, the rear driver-side brake 111, the front passenger-side brake 110, and/or the front driver-side brake 109.

In an alternative example the initial braking system employed may be either an ABS or Non ABS system, or one of the hybridized systems previously described and the detection of an unacceptable condition combined with the detection of a certain surface condition may cause the control system to default to a standard ESC, or to HNAABS/ESC stability control system where each wheel may be separately braked by an ABS or Non ABS control.

After the subsequent braking system has been engaged, said subsequent braking system becomes the new initial braking system discussed in step 200 of the functional block diagram, as depicted in FIG. 3. The method of controlling the HNAABS braking system will run in a looped fashion; with the subsequent braking system employed in step 203, becoming the new initial braking system discussed in step 200.

It will be apparent to those skilled in the art that various modifications and variations can be made to the present disclosure without departing from the spirit and scope of the present application. Thus, it is intended that the present application cover the modifications and variations of this disclosure provided they come within the scope of the appended claims and their equivalents.

What is claimed is:

1. A method of controlling a hybrid Non-ABS and ABS braking system of a vehicle, the method comprising the steps of:
engaging an initial braking system based on a default setting or input from an operator of the vehicle;
acquiring data from at least one sensor associated with the vehicle during the step of engaging the initial braking system;
sending the data provided by the at least one sensor to a control module of the vehicle;
analyzing the data provided by the at least one sensor; and
disengaging the initial braking system and engaging a subsequent braking system when a predetermined condition is detected by the control module.

2. The method accordingly to claim 1, wherein the initial braking system includes one of a Non-ABS braking system, an ABS braking system, and electronic stability control, and
wherein the subsequent braking system includes one of the Non-ABS braking system, the ABS braking system, and the electronic stability control not included in the initial braking system.

3. The method accordingly to claim 1, wherein the subsequent braking system is applied to at least one wheel of the vehicle.

4. The method according to claim 1, wherein the at least one sensor is at least one of a steering sensor, a braking sensor, and a directional dynamic sensor.

5. The method according to claim 1, wherein the initial braking system is a user selected braking system.

6. The method according to claim 1, wherein said step of analyzing includes solving an algorithmic equation to determine if the predetermined condition has occurred.

7. The method according to claim 1, wherein said step of analyzing includes comparing the data provided by the at least one sensor to various predetermined threshold limits to determine if the predetermined condition has occurred.

8. The method according to claim 1, wherein the predetermined condition includes at least one of oversteering, understeering, fishtailing, and rollover.

9. The method according to claim 1, wherein, after the step of disengaging the initial braking system and engaging the subsequent braking system, the subsequent braking system remains active until the operator activates the initial braking system.

10. The method according to claim 1, wherein, after the step of disengaging the initial braking system and engaging the subsequent braking system, the subsequent braking system remains active until the predetermined condition ceases and the initial braking system is re-engaged.

11. A method of controlling a hybrid Non-ABS and ABS braking system of a vehicle, the method comprising steps of:
engaging an initial braking system comprised of Non-ABS braking, wherein the Non-ABS braking allows wheels of the vehicle to be fully locked during braking;
acquiring data from at least one sensor associated with the vehicle;
sending the data provided by the at least one sensor to a control module of the vehicle;
analyzing the data provided by the at least one sensor; and
disengaging the initial braking system and engaging a subsequent braking system when a predetermined condition is detected.

12. The method according to claim 11, wherein the predetermined condition is at least one of oversteering, understeering, fishtailing, and rollover.

13. The method according to claim 11, wherein the predetermined condition is a movement of the vehicle in a direction that is contrary to braking and steering inputs provided by an operator of the vehicle.

14. The method according to claim 11, wherein said step of analyzing includes solving an algorithmic equation to determine if the predetermined condition has occurred.

15. The method according to claim 11, wherein the subsequent braking system includes at least one of ABS braking and electronic stability control.

16. The method according to claim 11, wherein the subsequent braking system is applied to at least one wheel of the vehicle.

17. The method according to claim 11, wherein the subsequent braking system applies ABS or electronic stability control selectively and independently to each wheel of the vehicle.

18. The method according to claim 11, wherein the at least one sensor is a steering sensor, a braking sensor, and a directional dynamic sensor.

19. The method according to claim 11, wherein, after the step of disengaging the initial braking system and engaging the subsequent braking system, the subsequent braking system remains active until an operator of the vehicle activates the initial braking system.

20. The method according to claim 11, wherein, after the step of disengaging the initial braking system and engaging the subsequent braking system, the subsequent braking system remains active until the predetermined condition ceases and the initial braking system is re-engaged.
